(19) United States
(12) Patent Application Publication
(10) Pub. No.: US 2006/0165869 A1
(43) Pub. Date: Jul. 27, 2006

(54) Process for producing dried powdery soybean and dried powdery soybean produced thereby

(75) Inventor: Koji Suzuki, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SC Foods, Inc., Shizuoka (JP)

(21) Appl. No.: 10/563,871

(22) PCT Filed: Nov. 13, 2003
(86) PCT No.: PCT/JP03/14459

§ 371 Date: Jan. 9, 2006

(30) Foreign Application Priority Data
Jul. 11, 2003 (JP) 2003-273751

(51) Int. Cl. A23L 1/20

(52) U.S. Cl. 426/634

(57) ABSTRACT

To provide a method for producing a dried powdery soybean in a relatively short time which contains almost no substance except ingredients of soybean, is resistant to oxidation, and is excellent in shelf life. The method comprises: (Immersing step) wherein water-washed soybeans and tocopherol are immersed in water for a certain time; (Steaming step) wherein the immersed soybeans are steamed; (Crushing step) wherein the steamed soybeans are crushed to a specified size; (Enzyme treating step) wherein a pectinase enzyme and the tocopherol are supplied to the crushed soybeans to prepare a mixture solution, then the mixture solution is agitated for a specified time at an activation temperature of the pectinase enzyme; (Deactivating step) wherein the mixture solution after the enzyme treatment is rapidly heated to deactivate the enzyme, then rapidly cooled; (Separating step) wherein the mixture solution is passed through a screen to micropulverize the solid material to a single cell level, then separated to obtain a slurry; (Drying step) wherein the slurry is dried by spray drying to obtain the dried powdery soybean.

### TECHNICAL FIELD

The present invention relates to a method for producing dried powdery soybean by using an enzyme, and to the dried powdery soybean produced by the method, and particularly relates to a method for producing dried powdery soybean, comprising a step for treating soybeans enzymatically by using pectinase produced by microorganisms of Bacillus genus to obtain a mixture solution; a deactivation step for deactivating the pectinase by heating the solution rapidly at a temperature for deactivating the pectinase, a step for rapidly cooling the heated solution, a step for micropulverizing the soybeans into the individual cells efficiently then separating, thereby to obtain a slurry, and a drying step for drying the slurry to have a water contents of 5 wt % or less; and also to the dried powdery soybean produced by the method.

### BACKGROUND ART

Different from general beans, soybean is free from starch, but contains protein by around 40% and oil by around 20%, and further has an amino acid composition which is not poor even in comparison with that of an animal protein, therefore, the soybean is food or food material which is nutritionally excellent.

On the other hand, soybean has so tough a tissue that it is hard to be digested and insufficiently absorbed even if it is only boiled and parched, though it is nutritionally excellent.

In Japan, from a long time ago, the soybean, which is hard to digest and absorb, has been processed into excellent foods such as miso (fermented soybean paste), soy sauce, tofu, freeze-dried bean curd, fermented soybeans, soybean flour, and yuba (soymilk skin). In these processed foods, during the production process, the tough tissue of soybean is destroyed or sufficiently pulverized by microorganisms, then indigestible ingredients of the soybean is removed or partially decomposed in order to improve the absorption.

Consequently, these processed foods allow a nutrient value of the soybean to be effectively utilized regardless of its tough tissue.

In addition, soybean is not only a raw material for above-described processed foods, but also a potential resource of oil, and currently imported soybeans are mainly used for producing oil. The refined oil is not only used for foods, but also for industries.

Soybeans processed to above-described foods are improved in digestion and absorption performance, thus allowing their excellent nutritive value to be effectively utilized.

Among the above-described processed foods, for example, in a process of producing a tofu, a pressed cake is generated, and the pressed cake is called a “tofu refuse”, around 50% of the raw material soybean, because 1 kg of soybean gives 4 to 5 kg of tofu, having water content of around 88% whereby showing that all amount of raw material soybean is not converted to a processed food. The problem that a by-product such as “tofu refuse” as the pressed cake is generated also in the production of yuba (soybean milk skin) which produces soybean milk in production process of said milk as well as a production of tofu.

In a processed food such as miso, which is prepared through the decomposition by using microorganisms to break the hard tissue of soybean, no such pressed cake as seen in tofu is generated, but an extremely long maturing time is required for preparing miso.

Furthermore, in a case that soybean is used as the raw material to produce oil, a large amount of de-fatted soybean is left. The soybean has an oil content of around 20% as described above, therefore, supposing that the de-fatted soybean after pressing oil is disposed, around 80% of the soybean becomes useless.

The de-fatted soybeans may be partially reused as a raw material of a food such as soy sauce, miso, and some kind of tofu, however, most of them is used for a feed in stock raising, therefore, the de-fatted soybeans are not effectively utilized as foods.

In view of these problems, a soybean or soybean cake is attempted to be pulverized mechanically into powder for use. However, according to the method, the soybean cells are destroyed during the pulverization, thereby odor specific to soybean remains, even when mixed with other foods, therefore, flavor of the food to be mixed is lost. As a result, a range of use and the amount of the soybean or soybean cake to use are limited.

The soybean protein extracted from the soybean cake is used in processed foods, however a use is limited because of its strong soybean odor.

Various methods are studied for containing the whole or almost whole of the used raw material soybean in the processed food. As an example, there is a method wherein soybean is pulverized; and supplied with water to obtain a slurry, then the slurry is heated at 60° C. to 100° C. for 5 to 180 minutes and homogenized under a high pressure (100 to 800 kg/cm²), and then the homogenized product is subjected to hydrolysis by using a neutral protease (an enzyme for decomposing a peptide bond in a protein and a peptide) produced by Bacillus subtilis, thereafter, a resulting reaction solution is heated then kept for a predetermined period to deactivate the enzyme, then dried by a spray drying process to obtain the soybean decomposition product (Japanese Patent KOKAI (LOPI) No. S61-219347).

According to the method, the whole ingredients of soybean can be utilized, and improved in digestion and absorption to human body. However, the pulverization of soybeans and the homogenization treatment conducted under a high pressure destroy the soybean cell, thus, there is a problem that a specific odor is remained from the intracellular ingredients of the soybean in the product thus obtained.

Since, as described above, the specific odor remaining in the soybean processed food comes from the soybean cell destructed during processing, a method to produce a processed food without destroying cell is attempted. As a method therefor, there is a method wherein water is added to the soybean, then left at room temperature for a prescribed period, and supplied with protopectinase to obtain a mixture, then the mixture is kept under stirring at room temperature (28° C., for example) for a long time (8 hours, for example) to conduct the enzyme treatment, thereafter, soybean milk is obtained by filtering the soybean. As the applicable enzyme for the enzyme treatment, a mixture of protopectinase and pectin esterase, pectin polygalacturonase, or polygalacturonase is disclosed to use (Japanese Patent KOKAI (LOPI) No. H08-89197).

As a method for producing a dispersible powdery food from beans, there is a method wherein soybean immersed in water is supplied with protopectinase produced by microorganisms of Rhizopus genus to conduct the enzyme treatment, after that, soybeans after the enzyme reaction is separated by filtration, then dried by freeze dry method to obtain a powdery food. As an applicable enzyme for the enzyme treatment, protopectinase produced by microorganisms of Aspergillus genus or Penicillium genus is disclosed to use (Japanese Patent Publication No. S42-22169).

According to these methods, the soybean is separated from each other into their respective single cells in a condition that the nutriments such as protein and fat are enclosed in the cell walls by decomposing binding of pectin between soybean cells according to action of enzyme without destroying the soybean cell. Consequently, the methods can provide processed foods with good digestion and absorption performance without odor generated from the destructed cells.

However, in the method, enzyme treatment is conducted at around room temperature, therefore a problem that sundry germs are readily grown thereby odor and bubbles are generated due to their fermentation is occurred.

In addition, the method takes a long time to complete the enzyme treatment, therefore, the production efficiency is low.

The enzyme acts normally at an optimal temperature of around 40° C. It loses the activity at a higher temperature, and acts weakly at a lower temperature. Therefore, if the temperature of the enzyme treatment is changed to prevent propagation of sundry germs, the action of enzyme is also decreased.

To solve these problems, there is a method which allows the enzyme treatment by pectinase produced by microorganisms of Bacillus genus to process soybean at a relatively high temperature within a short time wherein soybean immersed in water is heated and cooled in the presence of water, then pectinase produced by microorganisms of Bacillus genus and water are added thereto, then the enzyme treatment is conducted with stirring for a prescribed time to obtain a slurry in which single cells of soybean are dispersed, after that, the pectinase is deactivated by heating the slurry; then a powder prepared from beans except soybeans is supplied then dried by pneumatic drying or spray drying to obtain the dried powder (Japanese Patent No. 3256534).

### DISCLOSURE OF THE INVENTION

### Problems to be Solved by the Invention

According to the method disclosed in Japanese Patent No. 3256534, the pectinase produced by microorganisms of Bacillus genus is relatively resistant to heat, accordingly, the enzyme treatment can be conducted at a temperature as high as around 60° C., at which sundry germs are hard to grow.

In the case that the enzyme treatment is conducted by the pectinase produced by microorganisms of Bacillus genus, the enzyme treatment can be completed within a relatively short time, as a result, the productivity of processed foods is improved.

On the other hand, in the method disclosed in Japanese Patent No. 3256534, the slurry in which single soybean cells are dispersed cannot be directly dried, accordingly, the dried powder is obtained by preparing a secondary mixture by mixing a powder prepared from beans except soybeans, such as peas, kidney beans, and miscellaneous beans with the slurry obtained by the enzyme treatment then drying by pneumatic drying or spray drying.

The dried powder thus obtained contains a powder of bean except soybean. Particularly in the method according to an example of Japanese Patent No. 3256534, a powder prepared from 1.1 kg of peas as the raw material is added to the slurry prepared from 1.1 kg of soybean, therefore, the obtained dried powder contains a large amount of ingredients of pea. Furthermore, a process for obtaining powders from so large an amount of peas is required.

As described before, soybean contains so large an amount of fat and oil to be a raw material for oil-production. However, in the method described above the soybean is heated at a high temperature for steaming and deactivating the enzyme, further, the obtained powder is contacted with a high temperature air when drying, and that the enzyme treatment itself is conducted at a temperature as high as around 60° C., as a result, the fat and oil are easy to be oxidized.

In addition, the method, which comprises a deactivating process for heating for a relatively long prescribed time and cooling, deteriorates the important flavor and color tone of a food product and lowers its value. Further, because the method provides the dried powder which contains a large amount of oil originating from soybean, therefore, if quality of an obtained product is deteriorated due to oxidation, shelf life of the product is shortened and preservability thereof is decreased.

Further, in the method, the enzyme treating time is shortened by using pectinase produced by microorganisms of Bacillus genus, however, a preceding step for immersing to soybean swell for a time as long as 12 to 15 hours is still required. Therefore, the method takes a long time to pass through all the production steps.

An object of the present invention is to solve the drawbacks of the above-described conventional technologies, and to provide a method which uses almost all ingredients of a raw material soybean to produce the dried powder having very high digestion and absorption performance efficiently with no soybean-specific odor without generating pressed cake of the soybean, as well as to provide a method for producing the dried powdery soybean wherein damage occurred by heating and cooling for deactivation is removed, powder prepared from beans except soybeans is not included in the dried powder, and to prevent deterioration of the ingredients acidification of fat and oil included in the soybean during and after the production process, and to shorten a necessary time for the total production process; and to provide a dried powdery soybean produced by the method.

### MEANS TO SOLVE THE PROBLEMS

To achieve the above objects, the method for producing dried powdery soybean according to the present invention comprises:

a step for immersing a water-washed soybean in water preferably for 8 to 12 hours, where the soybean and the water have a ratio of 30:70 wt % for example, namely, the immersion water is preferably 2 to 4 times as much as soybean by weight;

a step for steaming the immersed soybean together with the water (160 kg per batch) under atmospheric pressure for 1 hour, or preferably under a pressures of 0.103 to 0.172 MPa (15 to 25 psi) for 20 to 50 minutes to shorten a treating time, though a condition varies depending on the amount of the raw material;

a step for crushing the steamed soybeans together with the immersion water in a crusher so that the soybean has preferably a size of 2 to 5 mm;

a step for treating the crushed soybean with an enzyme, wherein the crushed soybean and the immersion water are supplied with the pectinase produced by microorganisms of Bacillus genus to prepare a mixture solution, then the mixture is stirred at an activation temperature for the pectinase produced by microorganisms of Bacillus genus preferably for 30 minutes or more, thereby the crushed soybean dispersed in the mixture solution is decomposed by using the enzyme;

a step for deactivating the enzyme in the mixture solution, wherein the mixture solution after the enzyme treatment step is rapidly heated to a deactivation temperature for the pectinase produced by microorganisms of Bacillus genus;

a step for rapidly cooling the mixture solution after the deactivation step;

a step for micropulverizing, wherein the cooled mixture solution is passed through a screen having preferably a mesh size of less than 0.3 mm to micropulverize the solid material of soybean remaining in the mixture solution into the individual cells of soybean, then a slurry with the dispersed individual soybean cells is obtained;

a step for adding tocopherol by an amount depending on the quantity of fat in the soybean in any one of selected steps or a plurality of steps during said steps from the immersing step to the micropulverizing step, and then stirring; and

a step for drying the slurry prepared in the preceding step by spray drying to have a water content of 5% or less, preferably 3.0 to 3.5% (Claims 1 and 2).

In the above immersing step, the immersion water with the immersed soybean are agitated by blowing air in order to certainly conduct the immersion (Claim 3).

Furthermore, an amount of tocopherol added in the above production steps may be adjusted to 100 to 1000 ppm relative to the fat content in the raw material soybean (Claim 4).

The amount of the pectinase produced by microorganisms of Bacillus genus added in the enzyme treating step may be adjusted to 0.05 to 0.4% by weight ratio relative to the amount of raw material soybean (Claim 5).

The mixture solution in the enzyme treating step may have a temperature of 40° C. to 60° C. (Claim 6).

The mixture solution in the deactivating step may have a temperature of 75° C. to 95° C. for rapid heating (Claim 7).

The powder obtained after the drying step may be rapidly cooled to have a temperatures of 10° C. to 40° C. (Claim 8).

The dried powdery soybean according to the present invention is the dried powdery soybean produced by any one of the above-described processes (Claim 9).

### EFFECT OF THE INVENTION

According to the above-described structure of the present invention, a method to solve the drawbacks of the above-described conventional technologies, and to provide a method which uses almost all ingredients of a raw material soybean to produce the dried powder having very high digestion and absorption performance efficiently with no soybean-specific odor without generating pressed cake of the soybean, as well as to provide a method for producing the dried powdery soybean wherein a damage occurred by heating and cooling for deactivation is removed, powder prepared from beans except soybeans is not included in the dried powder, and to prevent deterioration of the ingredients due to acidification of fat and oil included in the soybean during and after the production process, and to shorten a necessary time for the total production process; and to provide a dried powdery soybean produced by the method can be provided.

### BRIEF DESCRIPTION OF THE DRAWING

FIG. 1 is a schematic drawing of outline of the steps for producing dried powdery soybean according to the present invention.

### BEST MODE FOR CARRYING OUT THE INVENTION

The embodiment of the present invention is described below.

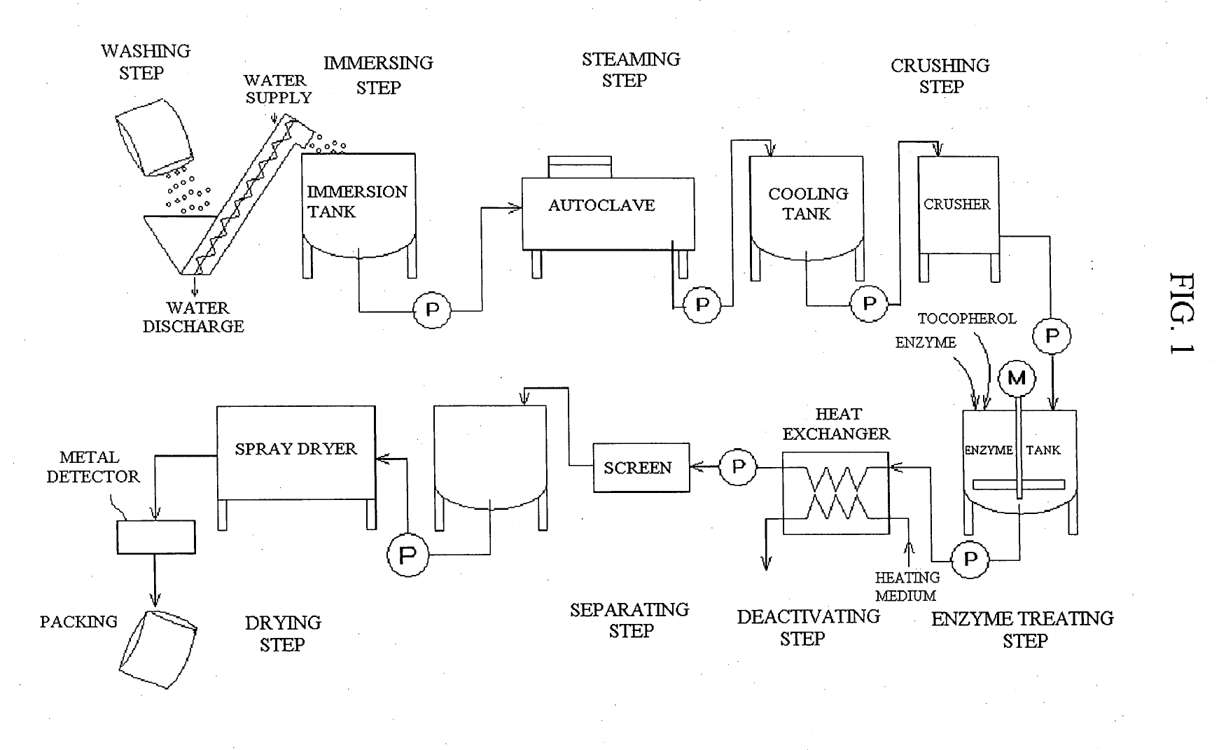

FIG. 1 is a schematic drawing of outline of steps for producing dried powdery soybean according to the present invention.

Steps for producing dried powdery soybean comprise roughly a “washing step” where raw material i.e., soybean is washed; a “immersing step” where the washed soybean is immersed in water to swell; a “steaming step” where the immersed soybean is steamed together with the immersion water; a “crushing step” where the steamed soybean is crushed to a prescribed size; a “enzyme treating step” where the crushed soybeans and the immersion water are supplied with a pectinase enzyme and tocopherol to prepare a mixture solution, then the mixture solution is subjected to an enzyme treatment; a “deactivating step” where the enzyme-treated mixture solution is heated to deactivate the enzyme; a “micropulverizing step” where the deactivated mixture solution is passed through a screen to micropulverize solid materials of soybean remaining in the mixture solution into individual cells of soybean to prepare a slurry in which the soybean cells are dispersed; and a “drying step” where a slurry prepared by the micropulverization is dried to obtain dried powdery soybean.

[Washing Step]

A washing apparatus used in the above-described washing step is an apparatus to wash the soybeans as the raw material with water to remove soil bacteria and the like and various types of the apparatus may be employed.

The washing apparatus in the embodiment shown in the drawing has a hopper for charging the soybeans as the raw material. The soybeans charged to the hopper are washed during transportation to an immersing tank which is described later, via a screw conveyer. The soybeans which are transported upward while being agitated by the screw conveyer are washed with washing water which flows down from the upper part of a sloped transportation route.

[Immersing Step]

After completing the washing, the soybeans are introduced in the immersing tank, then immersed in immersion water in the tank. According to the embodiment, four immersing tanks are installed to process 800 kg of soybeans in each tank (capacity of single immersing tank), and the washed soybeans are divided and charged to the individual tanks.

In each of the immersing tanks, the soybeans as the raw material and the immersion water of an amount enough to swell the soybeans are put. As an example, the immersion water is added at an amount of 2 to 4 times weight of soybeans. In the embodiment, a weight ratio of soybeans to water is 3:7.

Then, tocopherol may be added at an amount depending on the quantity of fat in soybeans.

Tocopherol has congeners of α through η. The α congener is strongest in vitamin effect such as antisterility factor, and is weakest in antioxidation action. Accordingly, depending on an object of tocopherol to add, any one of these congeners may be selected, or two or more of them may be mixed to add.

According to the present invention, tocopherol is added mainly to prevent fat in soybeans from oxidation. For example, a mixed tocopherol of D-6, δ, β, γ, and α congeners is added during the step to have a tocopherol amount of 100 to 350 ppm relative to a fat amount in the soybean.

During the step, about one third of the total amount of tocopherol may be added.

During immersing the soybeans, air is ejected from a pipe which is preferably positioned on a bottom of the immersing tank and provided with many micropores thereon to agitate the soybeans and the immersion water. Uniform swelling of soybeans is completed in a relatively short time by ejecting air to agitate. The immersing step can be completed at a water temperature of 12° C. for a time as short as 8 to 12 hours.

[Steaming Step]

After completing the swelling, the soybeans, together with the immersion water, are transported to a steamer, for example, via a pump and a conduit, to steam the soybeans.

Only the soybeans separated from the immersion water may be steamed. In the present embodiment, however, the soybeans swelled in the immersing step are steamed together with the immersion water, thereby the tocopherol added during immersing step and the ingredients of soybeans dissolved in the immersion water during immersing step can be employed as raw materials, further, isoflavone which is a soybean ingredient dissolved from the soybeans during steaming is recovered in the product together with water.

In the present embodiment, an autoclave having a capacity of 160 kg of soybeans is used as a steamer for charging high temperature steam, to steam under a pressure of 0.138 MPa for 24 minutes.

The steaming deactivates lipoxygenase existed in soybeans, thermally denaturates soybean protein to improve the digestion and absorption performance in human body, and softens a substance such as pectin binding the cells with each other, allowing the succeeding enzyme treatment to be easily performed.

The soybeans thus steamed are transported to a cooling tank together with the water via a pump and a conduit, and then cooled to have a prescribed temperature such as 60° C. to 70° C. according to the embodiment.

[Crushing Step]

By the above-mentioned manner, the soybeans cooled in the cooling tank are transported to a crusher, where the steamed soybeans are crushed to a size suitable for the enzyme treatment.

The soybeans are crushed into pieces to have an increased surface area, in order to shorten a time for enzyme treatment. During the crushing step, however, if the soybeans are pulverized to an excessively small size, the soybean cells may be destroyed during the pulverization. According to the embodiment, therefore, the soybeans are crushed into particles having a side length of around 2 to 5 mm so as not to destroy soybean cells and shorten the enzyme treating time.

According to the embodiment, the steamed soybeans, together with the water used in the immersing and steaming steps, are fed to a crusher to crush them, thereby fine soybean debris generated during crushing the soybeans, eluted matter, and the like can also be recovered.

Tocopherol may be added by around one third of the total feed in an auxiliary tank (not shown) where the crushed soybeans are transported after the crushing step.

[Enzyme Treating Step]

The crushed soybeans, together with the water used in immersing and steaming steps, are transported to an enzyme reaction tank, then agitated for a specified time. The pectinase produced by microorganisms of Bacillus genus, as an enzyme, is added to the tank to prepare a mixture solution, then the solution is agitated at a kept temperature of around 60° C. for a period from 15 to 30 minutes.

In the enzyme treating step, pectinase produced by microorganisms of Bacillus genus is added to decompose pectin which binds the soybean cells with each other by treating with enzyme, and then the soybeans are micropulverized into single cells to separate.

Pectinase enzyme is added by 0.05 to 0.4% of the weight of raw material soybeans, and, according to the embodiment, the pectinase enzyme was added by 0.15% of the weight of the raw material soybeans.

The mixture solution of soybeans crushed as such, water used for swelling the soybeans, the pectinase, and the tocopherol is agitated in the enzyme treating tank for around 30 minutes at a maintained temperature of around 60° C. for activating the pectinase enzyme, to complete the enzyme treatment.

The mixture solution is agitated at a rotational speed which does not damage the soybean cells and can separate the soybeans with the decomposed pectin into the individual cells, and, according to the embodiment, the mixture solution is agitated at a relatively slow rotational speed of around 40 rpm.

The enzyme treatment can be uniformly conducted to the mixture solution by conducting the enzyme treatment under agitation of the mixture solution, and a condition of the soybeans of which pectin is decomposed by the enzyme treatment becomes that extremely fine particles (soybean cells) are dispersed in the water by which the individual cells of the soybean are dispersed by the agitation.

[Deactivating Step]

After completing the enzyme treatment for a specified time, the enzyme-treated mixture solution is transported to a heater, where the mixture solution is rapidly heated to a temperature for deactivating the added pectinase, and, according to the embodiment, to around 95° C. The heating time is around 12 seconds.

The heater may have any structure as long as it can heat the enzyme-treated mixture solution to the specified temperature. In the present embodiment, as an example, a heat-exchanger, where the mixture solution is instantly heated through heat exchanging with a heating medium introduced from a heat source, and then rapidly cooled to allow prevention of the ingredients from deterioration and rancidity occurred by heating for too long a time is employed as the heater.

The mixture solution after deactivating the enzyme by heating is rapidly (in around 20 seconds) cooled to 80° C. or below similarly by a heat exchanger (not shown), and then is kept to have around 75° C. for a specified period.

The rapid heating accompanied by the rapid cooling provides the product with good odor and color, and high grade flavor.

[Micropulverizing Step]

As the foregoing processes, the soybean ingredients in the mixture solution after completing the enzyme treatment are in the condition that the cell-binding pectin is decomposed by the enzyme, however, the other soybean ingredients are remained as solid materials. Thus, a lump of said solid materials of the ingredient is further micropulverized into the individual cells and separated in a micropulverizing step. In the micropulverizing step, the soybeans in the mixture solution are destroyed into fine particles of cell level to obtain a slurry.

In the micropulverizing step, it is used an apparatus for micropulverizing having a screen on which specific holes are formed through which the mixture solution after the deactivating step are passed in the embodiment. In this embodiment, a mesh size of the screen is around 0.3 mm (0.012 inch).

The soybean solid material remaining in the deactivated mixture solution, which exists as a mass having a certain size, is constructed with a very weak binding force between the soybean cells, because the enzyme has acted to decompose the cell-binding pectin, as described before.

Therefore, if the mixture solution is passed through the screen under a high pressure for example, the soybean solid materials are caught by the screen without being passed through the screen, but the lump of said solid materials is relatively easily micropulverized by flow pressure into the individual cells and separated then passed through the screen depending on a very weak binding force between the cells.

As a result, a slurry in which the very fine particles (the soybean cells) obtained by separating the soybean ingredients into the individual cells are dispersed can be obtained by letting pass the mixture solution through the screen.

Around one third of the total amount of tocopherol may be added in an auxiliary tank shown in the upstream of a spray dryer where the mixture solution after the deactivating step is transported.

[Drying Step]

The soybean slurry thus obtained by the micropulverizing step using the micropulverizer is cooled to 70° C. or below, then held for a specified time. Then, the slurry is dried in a dryer to obtain a dried powdery soybean.

In the method disclosed in Japanese Patent No. 3256534, described above as a conventional technology, it is required to add powder of beans except soybeans to the slurry when drying the slurry. According to the method of the present invention, however, the slurry obtained by the enzyme treatment can be directly dried without adding powder prepared from materials except soybeans, such as powder prepared from other beans.

In the drying step according to the present invention, spray drying is employed. In the spray drying, the slurry is sprayed into hot air in a condition of very fine particles, then instantly dried by conducting rapid heat exchange. According to the method of the present invention, vacuum may be used instead of the hot air.

According to the drying step, a drying time is very short, therefore, deterioration of the product can be prevented, and powder can be obtained simultaneous with drying, further, particle size of the powder can be adjusted to an almost desired size depending on the spraying conditions. Consequently, it is not required to conduct a further pulverizing step after the drying step, therefore, no more damage is occurred on the soybean cells.

The dried soybean powder obtained after the drying step is adjusted to have a water content of 5% or less, preferably 3.0-3.5%.

[Cooling and Preservation]

The dried powdery soybean thus obtained is cooled to 40° C. or below, or preferably rapidly cooled to 35° C. or below under a nitrogen gas atmosphere, and is packed in gas-barrier packing bags or the like into which oxygen is not allowed to permeate. The packing bags are, as described later, preserved in a cool place at 15° C. or below.

Owing to the added tocopherol, the dried powdery soybean is resistant to oxidation occurred by the heating treatment during the production steps, and the final product (dried powdery soybean) is also resistant to oxidation, and is suitable for storage and other handling.

Preferably, prevention against oxidation and long shelf life of the dried powdery soybean prepared as such are obtained by filling nitrogen gas instead of air in a packing bag to prevent the dried powdery soybean from being contacted with oxygen.

The dried powdery soybean is preferably preserved in an adjusted environment to be resistant to oxidation, for example, at a temperature of 15° C. or below and in a dark place.

### EXAMPLES

TABLE 1
Example of production

| | | |
|---|---|---|
| Raw material | Soybeans (planted in the U.S.) | 800 kg |
| Tocopherol | RIKEN DRY E MIX | 400 rpm |
| | F-20 | |
| | Addition: in 3 steps | |
| Immersing step | 12 hours | Water 2000 kg |
| Steaming step | 25 min/25 psi Soybeans | |
| | 1000 kg | |
| Crushing step | 3 mm | |
| Enzyme treating step | Pectinase: XP534, | Weight ratio to |
| | Nagase ChemteX Corporation | soybeans: 15% |

### INDUSTRIAL APPLICABILITY

Use of Dried Powdery Soybean

The dried powdery soybean thus prepared can be used alone as a base material of food, diet food, emergency provisions, and the like. Since, as described before, soybean is a nutritionally excellent food containing protein, saccharide, and lipid in a balanced manner, and containing plenty of vitamins, it is expected to use not only as a relief food on emergency and disaster, material for children's school lunch, and a material for house-cooking, but also as a material for space food or the like, in the future.

Since the processing method of the present invention can convert the whole of soybean to foods with no waste left, the method can be a powerful means to solve the future food problem. In addition, the dried powdery soybean is dewatered so that it is light in weight to be conveniently transported and has good shelf life. Furthermore, the dried powdery soybean can be mixed with water or hot water before use, to form readily an emulsion, which is then conveniently used to make a liquid food.

The dried powdery soybean produced by the processing method according to the present invention is also preferable because of the miscibility with the other base materials for food.

Because of the specific odor, soybean has long been limited in use for other foods in spite of its high nutritive value. The powdery processed soybean or liquid processed soybean according to the present invention, however, has a high absorption rate to human body and emits almost no odor specific to soybeans so that it is able to be utilized in various foods to provide them with no sense of incompatibility.

That is, the dried powdery soybean obtained by the method according to the present invention is used together with soybean-isolated protein, extracted isoflavone, and fish-extracted DHC to add to the following foods, allowing suppression of the suppressed soybean-isolated protein odor, extracted isoflavone odor, and DHC odor. This is because the cells contained in the dried powdery soybean adsorb the odor.

For example, the dried powdery soybean according to the present invention can be used to add in bread such as leaf bread; confectionery; wheat flour food such as noodle; processed meat food such as hamburger and meat ball; mayonnaise; dressing; candy; cream; jam; curry, soup; ice cream; sherbet; fish processed food such as Kamaboko (steamed fish cake); soybean processed food such as tofu; and the like to increases their nutritional values. Furthermore, as described before, the dried powdery soybean produced by the method of the present invention is added to various foods, to transport no soybean-specific odor and to give no damage on the tastes and the flavors.

1-9. (canceled)

10. A method for producing dried powdery soybean comprising:
immersing a water-washed soybean in immersion water;
immersing a water-washed soybean in immersion water;
steaming the immersed soybean together with the immersion water;
crushing the steamed soybeans together with the immersion water in a crusher;
treating the crushed soybean with an enzyme, wherein the crushed soybean and the immersion water are supplied with pectinase produced by microorganisms of Bacillus genus to obtain a mixture solution, then the mixture solution is stirred at an activation temperature for the pectinase produced by microorganisms of Bacillus genus, thereby the crushed soybean dispersed in the mixture solution is dispersed by using the enzyme;
deactivating the enzyme in the mixture solution, wherein the mixture solution after the enzyme treatment step is rapidly heated at a deactivation temperature for the pectinase produced by microorganisms of Bacillus genus;
rapidly cooling the mixture solution with the deactivated enzyme;
micropulverizing, wherein a solid material of soybean remaining in the cooled mixture solution is micropulverized into the individual cells of soybean, to obtain a slurry in which the individual soybean cells are dispersed;
adding tocopherol of an amount depending on the quantity of fat to the soybean in any one or a plurality of said steps then stirring; and
drying the slurry prepared in the preceding step by spray drying to have a water content of 5% or less.

11. A method for producing dried powdery soybean comprising:
immersing a water-washed soybean in immersion water for 8 to 12 hours, wherein weight of the immersion water is 2 to 4 times as much as that of the soybean;
steaming the immersed soybean together with the immersion water under 0.103 to 0.172 MPa for 20 to 50 minutes;
crushing the steamed soybean together with the immersion water in a crusher so that the soybean has a size of 2 to 5 mm;
treating the crushed soybean with an enzyme, wherein the crushed soybean and the immersion water are supplied with pectinase produced by microorganisms of Bacillus genus to obtain a mixture solution, then the mixture solution is stirred at an activation temperature for the pectinase produced by microorganisms of Bacillus genus for 30 minutes or more, thereby the crushed soybean dispersed in the mixture solution is decomposed by using the enzyme;
deactivating the enzyme in the mixture solution, wherein the mixture solution after the enzyme treatment step is rapidly heated at a deactivation temperature for the pectinase produced by microorganisms of Bacillus genus;
rapidly cooling the mixture solution with the deactivated enzyme;
micropulverizing, wherein the cooled mixture solution is passed through a screen having a mesh size of less than 0.3 mm to micropulverize the solid material of soybean remaining in the mixture solution into the individual cells of soybean, to obtain a slurry with the dispersed individual soybean cells;
adding tocopherol of an amount depending on the quantity of fat in the soybean in any one or a plurality of said steps then stirring; and
drying the slurry prepared in the preceding step by spray drying to have a water content of 5% or less.

12. The method for producing dried powdery soybean as in claim 10, wherein the water and the soybean are agitated by blowing air into the immersion water in which the soybeans are immersed in the immersing step.

13. The method for producing dried powdery soybean as in claim 11, wherein the water and the soybean are agitated by blowing air into the immersion water in which the soybeans are immersed in the immersing step.

14. The method for producing dried powdery soybean as in claim 10, wherein the tocopherol in the immersing step is supplied to have a rate of 100 to 1000 ppm relative to the fat content in the raw material soybean.

15. The method for producing dried powdery soybean as in claim 11, wherein the tocopherol in the immersing step is supplied to have a rate of 100 to 1000 ppm relative to the fat content in the raw material soybean.

16. The method for producing dried powdery soybean as in claim 10, wherein the pectinase produced by microorganisms of Bacillus genus is supplied in the enzyme treating step to have a weight rate of 0.05 to 0.4% relative to the amount of raw material soybean.

17. The method for producing dried powdery soybean as in claim 11, wherein the pectinase produced by microorganisms of Bacillus genus is supplied in the enzyme treating step to have a weight rate of 0.05 to 0.4% relative to the amount of raw material soybean.

18. The method for producing dried powdery soybean as in claim 10, wherein the mixture solution in the enzyme treating step has a temperature of 40° C. to 60° C.

19. The method for producing dried powdery soybean as in claim 11, wherein the mixture solution in the enzyme treating step has a temperature of 40° C. to 60° C.

20. The method for producing dried powdery soybean as in claim 10, wherein the mixture solution in the deactivating step is heated at a temperature of 75° C. to 95° C.

21. The method for producing dried powdery soybean as in claim 11, wherein the mixture solution in the deactivating step is heated at a temperature of 75° C. to 95° C.

22. The method for producing dried powdery soybean as in claim 10, wherein the powder obtained after the drying step is rapidly cooled to have a temperatures of 40° C. or below.

23. The method for producing dried powdery soybean as in claim 11, wherein the powder obtained after the drying step is rapidly cooled to have a temperatures of 40° C. or below.

24. A dried powdery soybean produced by the method as claimed in claim 10.

25. A dried powdery soybean produced by the method as claimed in claim 11.
